(19) United States
(12) Patent Application Publication
(10) Pub. No.: US 2024/0234781 A1
(43) Pub. Date: Jul. 11, 2024

(54) FUEL CELL DEVICE HAVING A CASING

(71) Applicant: EKPO Fuel Cell Technologies GmbH, Dettingen (DE)

(72) Inventors: Fabian SCHMID, Frickenhausen (DE); Kai WAHL, Metzingen (DE)

(73) Assignee: EKPO Fuel Cell Technologies GmbH, Dettingen (DE)

(21) Appl. No.: 18/610,142

(22) Filed: Mar. 19, 2024

Related U.S. Application Data
(63) Continuation of application No. PCT/EP2022/075991, filed on Sep. 19, 2022.

(30) Foreign Application Priority Data
Sep. 23, 2021 (DE) 10 2021 210 639.0

(51) Int. Cl. H01M 8/2485; H01M 8/0258; H01M 8/0271

(52) U.S. Cl. CPC H01M 8/2485; H01M 8/0258; H01M 8/0271

(57) ABSTRACT

The aim of the invention is to provide a fuel cell device (100) which is easy and cost-effective to manufacture and preferably can be safely operated. In order to achieve said aim, it is proposed according to the invention that the fuel cell device (100) comprises the following: —a fuel cell stack unit (102); —a casing (104) which delimits an interior chamber (124), in which the fuel cell stack unit (102) is arranged; wherein the casing (104) has at least one wall (130), preferably a casing lid (118), and wherein the fuel cell stack unit (102) is secured to the wall (118), preferably to the casing lid (118).

### RELATED APPLICATION

This application is a continuation of international application No. PCT/EP2022/075991 filed on Sep. 19, 2022, and claims the benefit of German application No. 10 2021 210 639.0 filed on Sep. 23, 2021, which are incorporated herein by reference in their entirety and for all purposes.

### FIELD OF DISCLOSURE AND BACKGROUND

The present invention relates to a fuel cell device.

The object of the present invention is to provide a fuel cell device which is easy and cost-effective to manufacture and preferably can be safely operated.

### SUMMARY OF THE INVENTION

This object is achieved according to the invention by a fuel cell device having the features of claim 1.

The fuel cell device preferably comprises the following:
a fuel cell stack unit;
a casing which delimits an interior chamber, in which the fuel cell stack unit is arranged;
   wherein the casing comprises at least one wall—preferably a casing lid—
   wherein the fuel cell stack unit is secured to the wall—preferably to the casing lid.

The fuel cell stack unit is preferably mounted and/or connected to the wall—in particular, to the casing lid. In this case, a seal can optionally be formed and/or provided between the fuel cell stack unit and the wall—in particular, the casing lid.

The fuel cell stack unit preferably comprises a fuel cell stack.

The fuel cell stack preferably comprises a plurality of fuel cell elements arranged in a stacking direction. The fuel cell elements are in particular plate-shaped units which have different components for the electrochemical conversion of fuel, for conducting power, and for conducting fluid.

The term, “in particular,” is preferably used in the context of this description and the appended claims to describe optional features.

The fuel cell stack unit of the fuel cell device preferably comprises two end plates, wherein the fuel cell stack of the fuel cell stack unit is preferably clamped between the two end plates by means of a clamping device—in particular, by means of a plurality of clamping elements of the clamping device.

The fuel cell stack of the fuel cell stack unit is preferably arranged between the two end plates.

For example, it is conceivable for the fuel cell stack unit to comprise an upper end plate and a lower end plate.

The upper end plate and the lower end plate are preferably arranged on end regions of the fuel cell stack unit facing away from one another.

In an operating state of the fuel cell device, the upper end plate is arranged, for example, on an upper end region of the fuel cell stack unit in the direction of gravity, wherein the lower end plate is arranged, for example, on a lower end region of the fuel cell stack unit in the direction of gravity.

The fuel cell stack unit preferably comprises a clamping device by means of which the fuel cell stack of the fuel cell stack unit is clamped between two end plates of the fuel cell stack unit.

The clamping device preferably comprises a plurality of clamping elements—for example, so-called “tie rods.”

It may be advantageous if the clamping elements of the clamping device are arranged directly or indirectly on the end plates of the fuel cell stack unit such that the end plates of the fuel cell stack unit are pulled towards one another and/or that a tensile force acts upon the end plates of the fuel cell stack unit which pulls the end plates towards one another.

The housing preferably comprises an upper housing cover and a lower housing cover.

The upper housing cover and the lower housing cover of the housing are preferably arranged on end regions of the housing of the fuel cell device which face away from one another.

It can be provided that one or more casing lids—in particular, the upper casing lid and/or the lower casing lid—be part of the clamping device and/or form or comprise at least a part or all of one end plate or both end plates of the fuel cell stack unit.

It may be advantageous if the casing also comprises a casing shell which preferably connects the upper casing lid and the lower casing lid to one another.

An interior of the housing of the fuel cell device is preferably delimited by the upper housing cover, the housing shell, and the lower housing cover.

The wall—in particular, the casing lid—to which the end plate is secured preferably comprises an inner side facing the interior chamber and/or an outer side facing away from the interior chamber.

The upper casing lid, the lower casing lid, and/or the casing shell preferably comprise or are formed from a metallic material—for example, aluminum.

The casing of the fuel cell device preferably encloses the interior chamber of the casing in a gas-tight manner.

In an operating state of the fuel cell device, the upper casing lid is arranged, for example, on an upper end region of the fuel cell stack unit in the direction of gravity, wherein the lower casing lid is arranged, for example, on a lower end region of the fuel cell stack unit in the direction of gravity.

In one embodiment of the fuel cell device, it is provided that the fuel cell device comprise a fixed bearing device and/or a floating bearing device. Furthermore, it can be provided that the fuel cell device comprise two or more than two fixed bearing devices and/or one, two, or more than two floating bearing devices.

It may be advantageous if the fuel cell stack unit is fixedly mounted on one side in the casing of the fuel cell device by means of the fixed bearing device.

The fuel cell stack unit is preferably fixedly mounted at one of its end regions in the casing of the fuel cell device—for example, on a casing lid of the casing.

An end plate—in particular, a lower end plate—of the fuel cell stack unit is preferably secured to the wall of the casing—in particular, to the casing lid of the casing.

For example, it can be provided that the lower end plate of the fuel cell stack unit be screwed to the lower casing lid.

In one embodiment of the fuel cell device, it is provided that an end plate of the fuel cell stack unit be secured to the wall—in particular, to the casing lid—wherein the end plate of the fuel cell stack unit which is secured to the wall—in particular, to the casing lid—preferably comprises or is formed from a plastic material.

The end plate secured to the wall—in particular, to the casing lid—is in particular a plastic end plate.

The plastic end plate is preferably an injection-molded component.

The in particular metallic casing lid of the casing of the fuel cell device to which the plastic end plate is secured forms in particular a pressure distributor plate by means of which a substantially uniform surface pressure can be exerted on fuel cell elements of the fuel cell stack of the fuel cell stack unit.

In one embodiment of the fuel cell device, it is provided that an end plate of the fuel cell stack unit which is secured to the wall—in particular, to the casing lid—comprise one or more passage portions which are passed through the wall—in particular, through the casing lid—wherein the one or more passage portions are preferably designed such that a medium can be passed through them.

For example, an anode gas, a temperature control medium, or a cathode gas can be passed through a passage portion as a medium.

The end plate of the fuel cell stack unit, which comprises the passage portions, is in particular a media guide end plate.

A corresponding passage portion preferably comprises or delimits one or more channel portions of one or more channels by means of which a fluid can be supplied to the fuel cell stack of the fuel cell stack unit or by means of which a fluid can be removed from the fuel cell stack of the fuel cell stack unit.

A channel portion of a corresponding passage portion preferably opens into what is known as a “manifold” of the fuel cell stack of the fuel cell stack unit.

It may be advantageous if the end plate comprises two passage portions, wherein a corresponding passage portion preferably delimits three channel portions.

The channel portions of a corresponding passage portion are preferably fluidically separated from one another.

The channel portions are preferably each delimited by a channel wall.

In one embodiment of the fuel cell device, it is provided that a channel wall of a corresponding channel portion of a corresponding passage portion have no weld seams.

The passage portions are preferably formed in one piece with the end plate which is secured to the wall—in particular, to the casing lid.

In particular, it can be provided that the passage portions of the plastic end plate be formed in one piece with the plastic end plate.

Preferably, leakage in the region of the passage portion can be reduced or avoided by the fact that the passage portions are formed in one piece with the plastic end plate and that a channel wall of a corresponding channel portion of a corresponding passage portion has no weld seams.

In one embodiment of the fuel cell device, it is provided that the passage portions project away from a base plate of the end plate which is secured to the wall—in particular, to the casing lid.

The passage portions in particular project away from a base plate of the plastic end plate.

The passage portions are preferably substantially cylindrical—in particular, in a direction parallel to a stacking direction of a fuel cell stack of the fuel cell stack unit.

In one embodiment of the fuel cell device, it is provided that a height of the passage portions be equal to or greater than a thickness of the wall—in particular, of the casing lid—to which the fuel cell stack unit is secured. Alternatively, it can be provided that a height of the passage portions be smaller than a thickness of the wall—in particular, of the casing lid—to which the fuel cell stack unit is secured.

For example, it is conceivable for the passage portions to project from through-openings in the wall—in particular, in the casing lid—on an outer side facing away from the interior chamber of the casing of the fuel cell device.

In one embodiment of the fuel cell device, it is provided that the wall—in particular, the casing lid—to which the fuel cell stack unit is secured comprise one or more through-openings, through which one or more passage portions of an end plate of the fuel cell stack unit are passed.

The through-openings are preferably substantially cylindrical—in particular, in a direction parallel to a stacking direction of a fuel cell stack of the fuel cell stack unit.

A cross-section of the through-openings of the wall—in particular, of the casing lid—preferably substantially corresponds to a cross-section of the passage portions.

For example, it is conceivable for the wall—in particular, the casing lid—to comprise a plurality of through-openings, wherein in each case a passage portion is passed through a through-opening.

A number of through-openings corresponds in particular to a number of passage portions.

Alternatively, it is conceivable for the wall—in particular, the casing lid—to comprise a plurality of through-openings, wherein a plurality of passage portions are passed through a through-opening.

For example, it is conceivable for three passage portions of the end plate of the fuel cell stack unit to each be passed through a through-opening of the wall—in particular, of the casing lid.

In one embodiment of the fuel cell device, it is provided that the fuel cell device further comprise one or more media guide elements which are arranged outside the interior chamber of the casing of the fuel cell device.

It may be advantageous if the one or more media guide elements are sealingly connected to the passage portions of the end plate which is secured to the wall—in particular, to the casing lid.

Preferably, the one or more media guide elements each comprise or delimit a channel portion of a channel by means of which a fluid can be supplied to the fuel cell stack of the fuel cell stack unit or by means of which a fluid can be removed from the fuel cell stack of the fuel cell stack unit.

It may be advantageous in particular if a channel portion of a media guide element and a channel portion of a passage portion together form a media guide channel, by means of which a fluid can be supplied to the fuel cell stack of the fuel cell stack unit or by means of which a fluid can be removed from the fuel cell stack of the fuel cell stack unit.

The one or more media guide elements are preferably secured—in particular, releasably—to the wall—in particular, to the casing lid.

For example, it is conceivable for the media guide elements to be screwed to the wall—in particular, to the casing lid.

By releasably securing the one or more media guide elements, a replacement of the one or more media guide elements and thus preferably also a repair of the fuel cell device can be facilitated.

Preferably, the one or more media guide elements are secured to a first side of the casing lid—for example, to an underside of the casing lid and/or to an outer side, facing away from the interior chamber of the casing of the fuel cell device, of the casing lid.

An end plate of the fuel cell stack unit is preferably secured to a second side of the casing lid, which faces away from the first side—in particular, to an upper side of the casing lid and/or to an inner side, facing the interior chamber of the casing of the fuel cell device, of the casing lid.

The media guide elements preferably each comprise one or more media connections.

It may be advantageous if the fuel cell device comprises media guide elements for supplying and removing anode gas, for supplying and removing cathode gas, and/or for supplying and removing temperature control medium.

The media guide elements preferably comprise or are formed from a plastic material.

In particular, it can thereby be achieved that media connections of the media guide elements are electrically decoupled from the casing lid, which is in particular metallic.

As media guide elements, the fuel cell device comprises in particular anode gas guide elements, temperature control medium guide elements, and cathode gas guide elements.

A channel wall of a channel portion of a corresponding temperature control medium guide element and/or of a corresponding cathode gas guide element preferably has no weld seams.

It may be advantageous if the temperature control medium guide elements and/or the cathode gas guide elements are formed substantially in one piece.

The temperature control medium guide elements and/or the cathode gas guide elements are preferably injection-molded components—in particular, plastic injection-molded components.

It can be provided that an anode gas guide element comprise one or more weld seams—for example, one or more hot gas weld seams and/or one or more laser weld seams.

It may be advantageous if, of the media guide elements, only the anode gas guide element comprises one or more weld seams—in particular, one or more hot gas weld seams—so that a total length of the weld seams of the fuel cell device is preferably reduced.

The anode gas guide element can in particular be of multipart design.

The anode gas guide element preferably comprises a plurality of injection-molded components—in particular, a plurality of plastic injection-molded components.

It may be particularly advantageous if the anode gas guide element is an anode gas guide module.

In one embodiment of the fuel cell device, it is provided that the fuel cell device further comprise the following:

a) a first sealing device for sealing between the wall—in particular, the casing lid—and an end plate of the fuel cell stack unit which is secured to the wall—in particular, to the casing lid; and/or

b) a second sealing device for sealing between a passage portion of an end plate of the fuel cell stack unit which is secured to the wall—in particular, to the casing lid—and a media guide element of the fuel cell device.

The first sealing device is in particular an internal sealing device, which is preferably designed for sealing in an interior chamber of the casing of the fuel cell device.

The second sealing device is preferably an external sealing device, which is preferably designed for sealing on an outer side facing away from the interior chamber of the casing of the fuel cell device.

In one embodiment of the fuel cell device, it is provided that the fuel cell device comprise media connections arranged outside the casing of the fuel cell device, wherein a corresponding media connection opens into a media guide channel which comprises channel portions of a media guide element and/or a passage portion of an end plate of the fuel cell stack unit, which are secured—in particular, mechanically connected—to the wall—in particular, to the casing lid.

It can be particularly advantageous if a channel portion of a corresponding media guide element is sealingly connected to a channel portion of a corresponding passage portion by means of a sealing element—in particular, by means of a molded seal.

In one embodiment of the fuel cell device, it is provided that the fuel cell device comprise the following:

a) one or more first—in particular, internal—sealing elements for sealing between the wall—in particular, the casing lid—and an end plate of the fuel cell stack unit which is secured to the wall—in particular, to the casing lid; and/or

b) one or more second—in particular, external—sealing elements for sealing between a passage portion of an end plate of the fuel cell stack unit which is secured to the wall—in particular, to the casing lid—and a media guide element of the fuel cell device.

The sealing element which sealingly connects the channel portion of a corresponding media guide element to the channel portion of a corresponding passage portion is preferably a second sealing element.

The one or more first sealing elements and/or the one or more second sealing elements are preferably molded seals.

The first and second sealing elements preferably comprise or are formed from a plastic material—in particular, an elastomeric material.

It may be advantageous, for example, if the fuel cell device comprises only a single first sealing element, which is preferably formed in one piece.

The individual first sealing element preferably comprises two sealing portions and/or two connecting portions.

A corresponding sealing portion of the individual first sealing element is preferably closed in an annular manner.

In particular, it can be provided that a corresponding sealing portion of the individual first sealing element radially surround a corresponding passage portion—in particular, be closed in an annular manner.

Preferably, one connecting portion in each case connects two sealing portions to one another, so that the individual first sealing element is preferably closed in an annular manner overall.

It may also be advantageous if the fuel cell device further comprises only two second sealing elements, which are preferably each formed in one piece.

The two second sealing elements preferably each comprise three sealing portions and/or two connecting portions.

A corresponding sealing portion of the two second sealing elements is preferably closed in an annular manner.

In particular, it can be provided that a corresponding sealing portion of a second sealing element radially surround a channel portion of a media guide element.

Preferably, a corresponding connecting portion of the two second sealing elements in each case connects two sealing portions of the two second sealing elements.

In one embodiment of the fuel cell device, it is provided that

a) the wall—in particular, the casing lid—to which an end plate of the fuel cell stack unit is secured and/or the end plate which is secured to the wall—in particular, to the casing lid—comprise one or more first receiving grooves for receiving one or more first sealing elements; and/or

b) an end face of a corresponding passage portion of an end plate of the fuel cell stack unit which is secured to the wall—in particular, to the casing lid—comprise one or more second receiving grooves for receiving one or more second sealing elements.

In particular, it can be provided that the wall—in particular, the casing lid—to which the end plate of the fuel cell stack unit is secured comprise an individual first receiving groove for receiving the individual first sealing element on an inner side facing the interior chamber of the casing.

A shape of the individual first receiving groove preferably corresponds to a shape of the individual first sealing element.

The individual first receiving groove has, for example, a rectangular cross-section and can therefore in particular be a rectangular groove.

In particular, it can be provided that a corresponding passage portion of the end plate which is secured to the wall—in particular, to the casing lid—comprise a second receiving groove for receiving an individual second sealing element.

A shape of the corresponding second receiving groove preferably corresponds to a shape of a corresponding second sealing element.

A corresponding second receiving groove has, for example, a rectangular cross-section and can therefore in particular be a rectangular groove.

It may be advantageous if a corresponding first receiving groove has a depth which is less than a thickness of a corresponding first sealing element in a state before assembly of the fuel cell device.

The one or more first sealing elements are preferably compressed between an inner side, facing the interior chamber of the casing, of the wall—in particular, of the casing lid—to which the end plate of the fuel cell stack unit is secured, and the end plate which is secured to the wall—in particular, to the casing lid.

It may also be advantageous if a corresponding second receiving groove has a depth which is less than a thickness of a corresponding second sealing element in a state before assembly of the fuel cell device.

The one or more second sealing elements are preferably compressed between an end face of a corresponding passage portion of an end plate of the fuel cell stack unit which is secured to the wall—in particular, to the casing lid—and a corresponding media guide element.

In one embodiment of the fuel cell device, it is provided that clamping elements of a clamping device of the fuel cell device be secured—in particular, mechanically connected—to a casing lid of the casing—in particular, to a lower casing lid.

For example, it is conceivable for the clamping elements to be screwed to the casing lid.

The clamping elements are preferably passed through the end plate of the fuel cell stack unit which is secured to the wall—in particular, to the casing lid.

In one embodiment of the fuel cell device, it is provided that valves, sensors, and/or actuators of the fuel cell device be arranged outside the interior chamber of the casing of the fuel cell device, which interior chamber is delimited by the casing of the fuel cell device.

Valves, sensors, and/or actuators of the fuel cell device can, for example, be secured to an outer side, facing away from the interior chamber of the casing, of the casing lid.

Alternatively or additionally, it can be provided that valves, sensors, and/or actuators of the fuel cell device be secured to media guide elements of the fuel cell device.

Preferably, it can be achieved that connecting cables for the valves, sensors, and/or actuators do not have to be guided through the casing—in particular, not through the casing lid.

In particular, an additional sealing point can thereby be dispensed with.

Further preferred features and/or advantages of the invention form the subject matter of the following description and the drawings illustrating exemplary embodiments.

### BRIEF DESCRIPTION OF THE DRAWINGS

FIG. 1 is a schematic perspectival view of an embodiment of a fuel cell device;

FIG. 2 is a section of a schematic perspectival view of the embodiment of a fuel cell device from FIG. 1 from below;

FIG. 3 is a schematic perspectival view of a casing lid and media guide elements of the embodiment of a fuel cell device from FIG. 1;

FIG. 4 is a schematic perspectival view of an end plate of a fuel cell stack unit of the embodiment of a fuel cell device from FIG. 1 from below;

FIG. 5 is a schematic perspectival view of an end plate of a fuel cell stack unit and a first—in particular, internal—sealing element of the embodiment of a fuel cell device from FIG. 1 from above;

FIG. 6 is a schematic perspectival view of the end plate of a fuel cell stack unit of the embodiment of a fuel cell device from FIG. 1 from above;

FIG. 7 is a schematic perspectival view of the first—in particular, internal—sealing element of the embodiment of a fuel cell device from FIG. 1 from above;

FIG. 8 is a schematic bottom view of the embodiment of a fuel cell device from FIG. 1;

FIG. 9 is a schematic section through the embodiment of a fuel cell device from FIG. 1 along line IX-IX in FIG. 8, wherein in particular only one end plate of a fuel cell stack unit, which is secured to a casing lid of the fuel cell device, as well as the casing lid and the media guide elements fixed thereto are shown;

FIG. 10 is a schematic section through the embodiment of a fuel cell device from FIG. 1 along the line X-X in FIG. 8, wherein in particular only one end plate of a fuel cell stack unit, which is secured to a casing lid of the fuel cell device, and the casing lid and the media guide elements fixed thereto are shown;

FIG. 11 is an enlarged view of region XI in FIG. 9;

FIG. 12 is a schematic bottom view of the embodiment of a fuel cell device from FIG. 1, wherein media guide elements of the fuel cell device are not shown;

FIG. 13 is a schematic section through the embodiment of a fuel cell device from FIG. 1 along the line XIII-XIII in FIG. 12, wherein in particular only one end plate of a fuel cell stack unit, which is secured to a casing lid of the fuel cell device, and the casing lid are shown;

FIG. 14 is a schematic section through the embodiment of a fuel cell device from FIG. 1 along the line XIV-XIV in FIG. 12, wherein in particular only one end plate of a fuel cell stack unit, which is secured to a casing lid of the fuel cell device, and the casing lid are shown;

FIG. 15 is a schematic section through the embodiment of a fuel cell device from FIG. 1 along the line XV-XV in FIG. 12, wherein in particular only one end plate of a fuel cell stack unit, which is secured to a casing lid of the fuel cell device, and the casing lid are shown;

FIG. 16 is a schematic perspectival view of media guide elements, temperature control medium guide elements, and cathode gas guide elements, of the embodiment of a fuel cell device from FIG. 1 from above;

FIG. 17 is a schematic perspectival view of media guide elements, temperature control medium guide elements, and cathode gas guide elements, of the embodiment of a fuel cell device from FIG. 1 from below;

FIG. 18 is a schematic perspectival view of a media guide element—in particular, an anode gas guide module—of the embodiment of a fuel cell device from FIG. 1 from above;

FIG. 19 is a schematic perspectival view of a media guide element—in particular, an anode gas guide module—of the embodiment of a fuel cell device from FIG. 1 from below;

FIG. 20 is a schematic perspectival view of a passive recirculation element of the embodiment of a fuel cell device from FIG. 1 from above; and

FIG. 21 is a schematic perspectival view of a passive recirculation element of the embodiment of a fuel cell device from FIG. 1 from below.

The same or functionally equivalent elements are provided with the same reference signs in all figures.

### DETAILED DESCRIPTION OF THE DRAWINGS

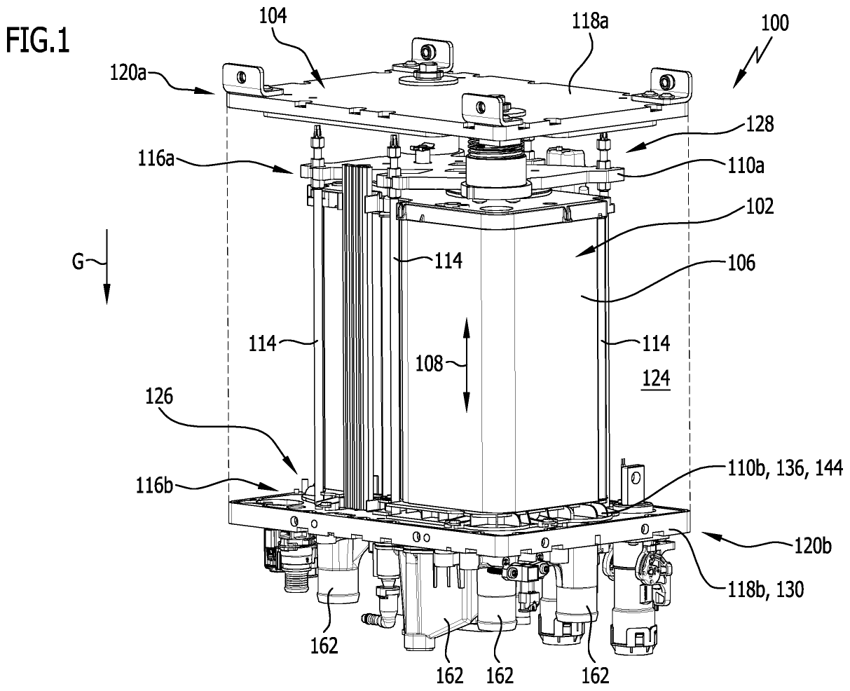

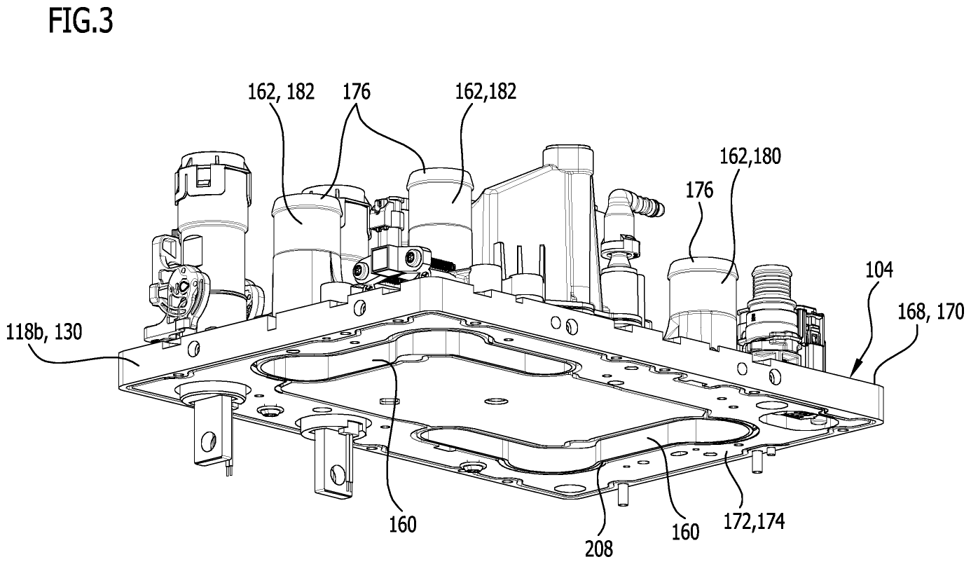

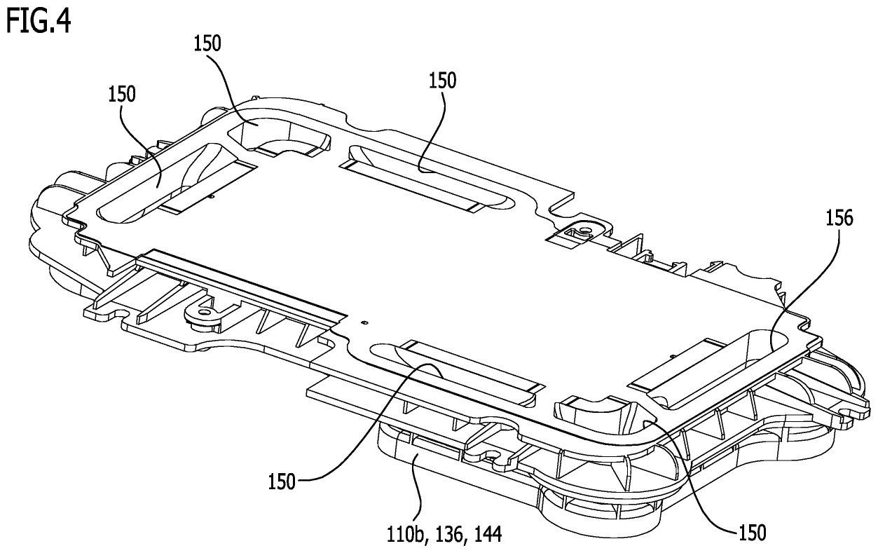

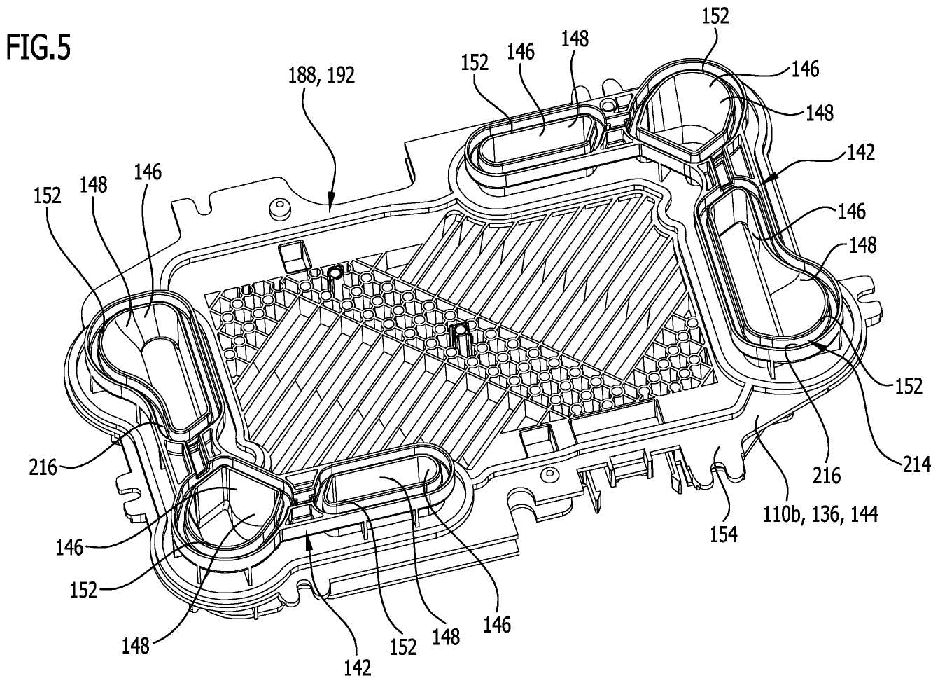

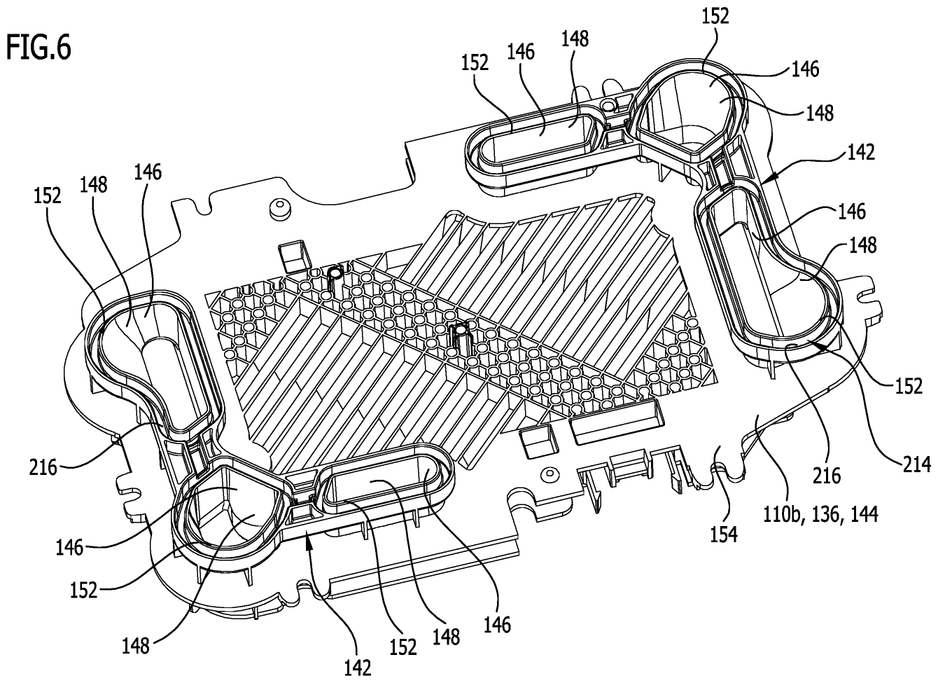

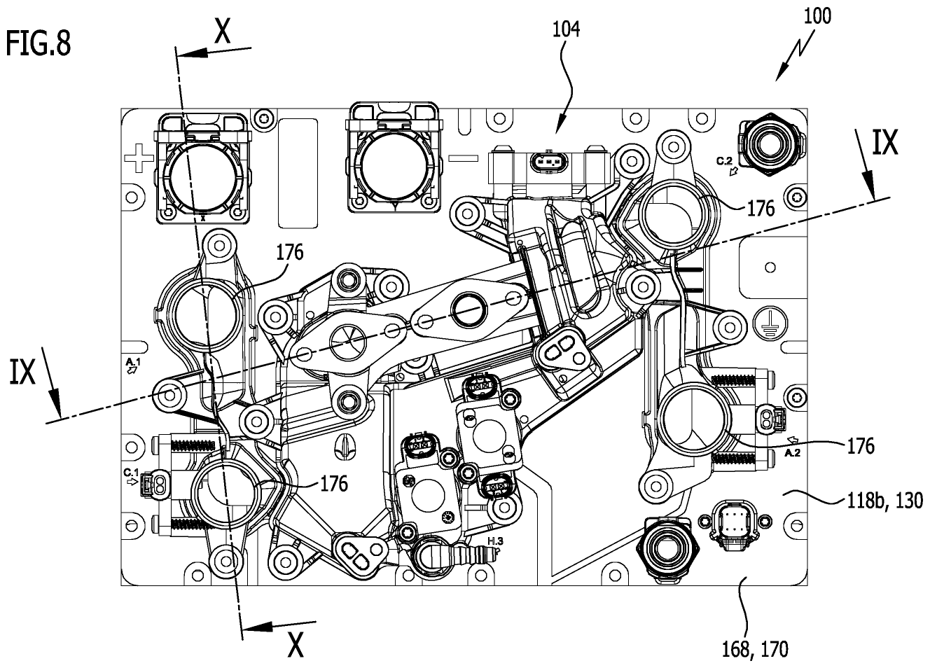

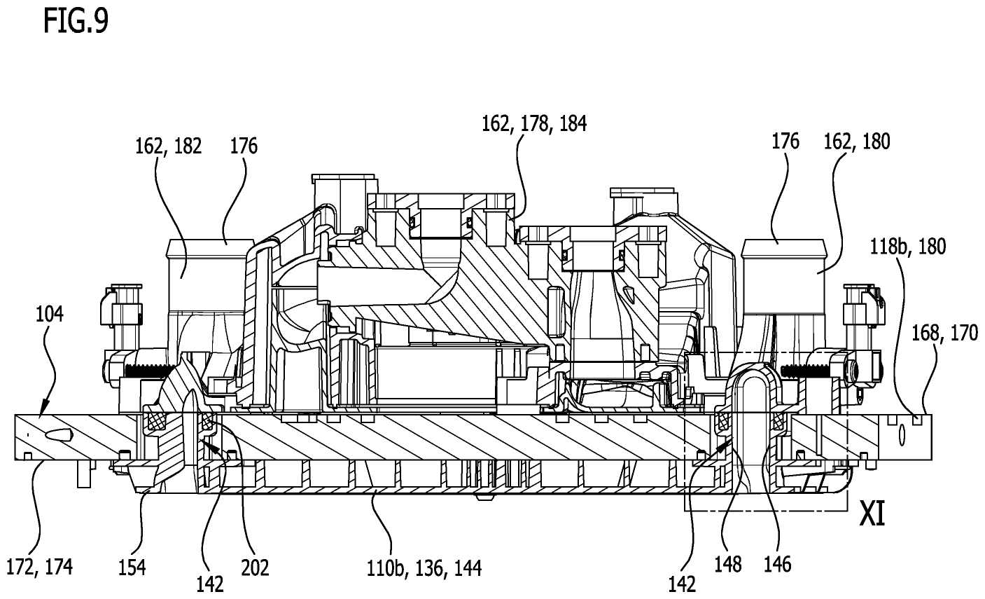

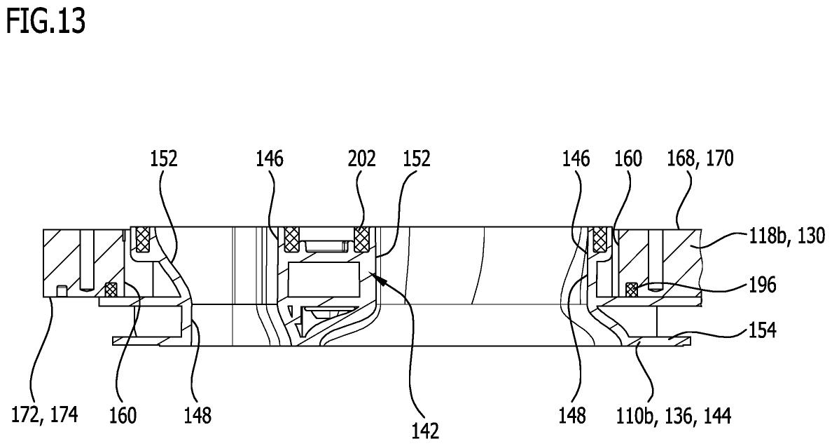

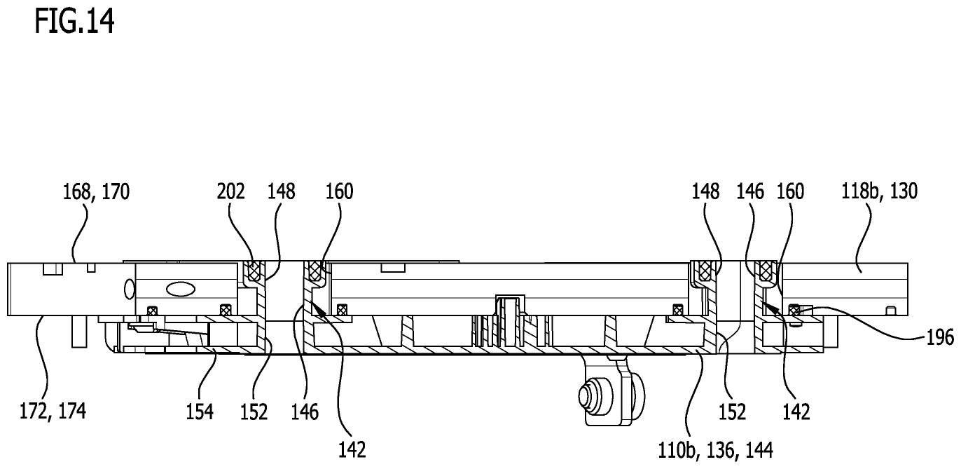

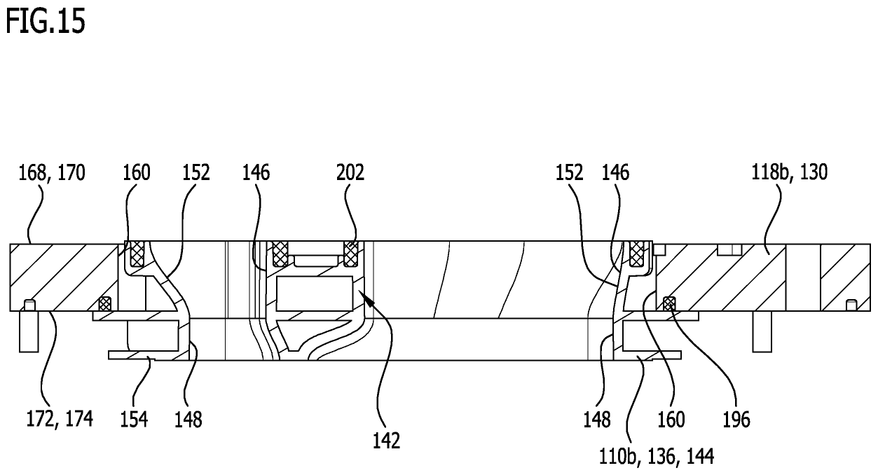

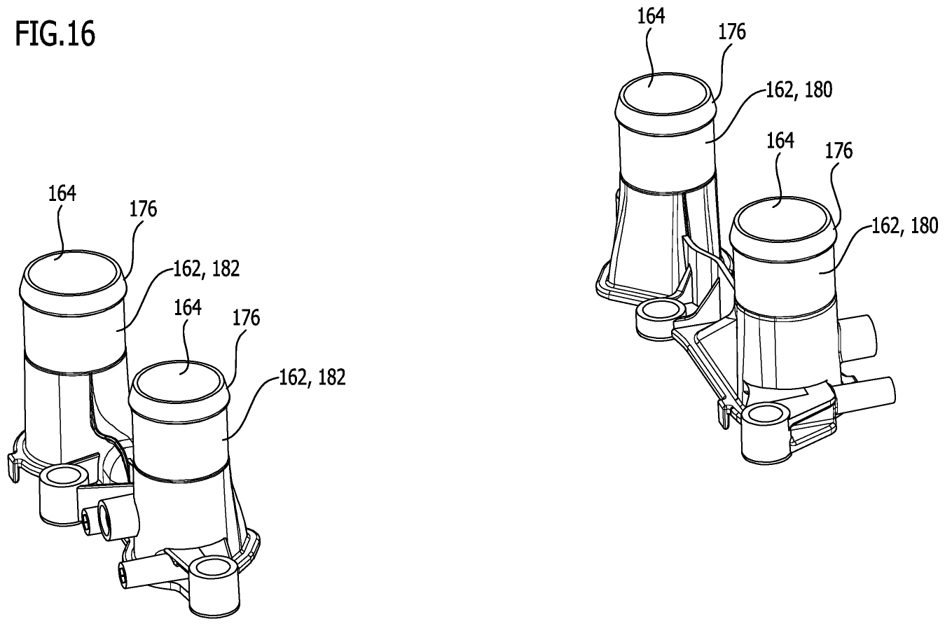

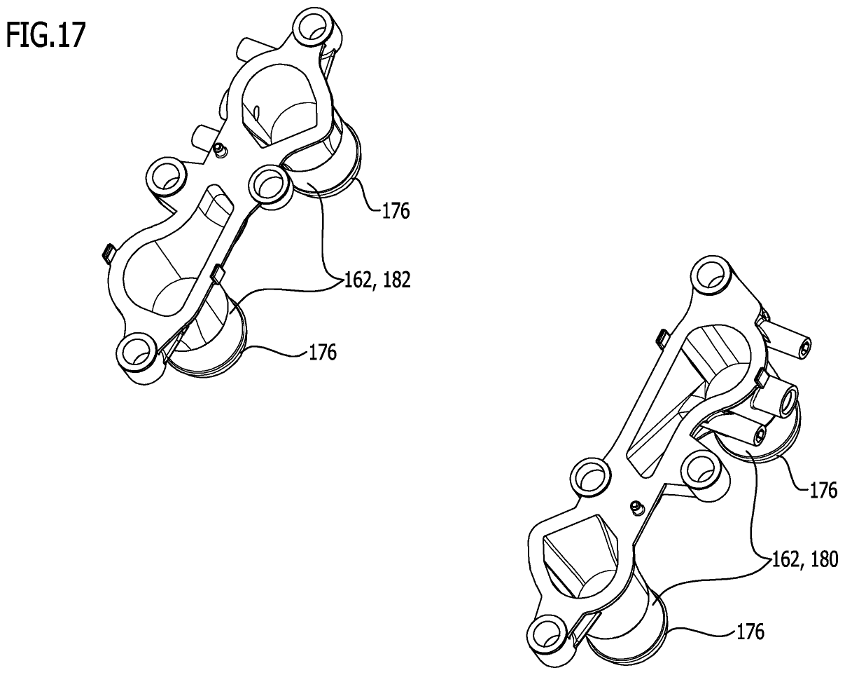

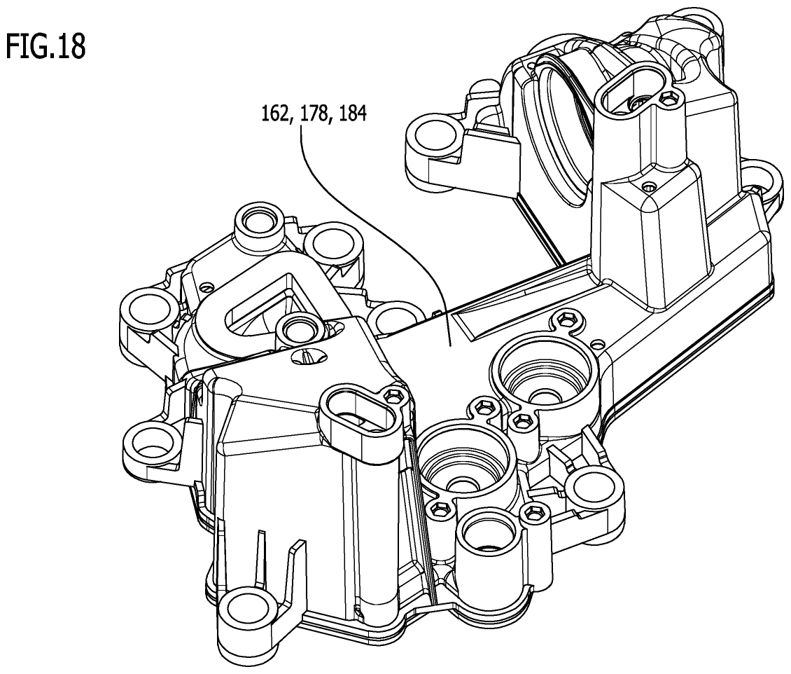

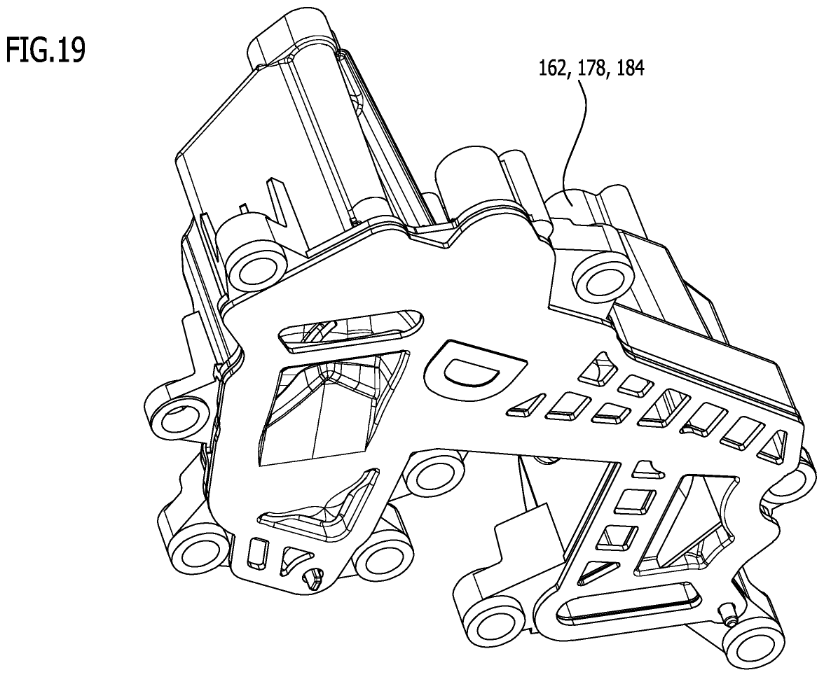

A fuel cell device shown schematically in FIGS. 1 to 21 and designated as a whole by 100 preferably comprises a fuel cell stack unit 102.

The fuel cell device 100 preferably further comprises a casing 104 in which the fuel stack unit 102 is arranged.

The fuel cell stack unit 102 preferably comprises a fuel cell stack 106.

The fuel cell stack 106 preferably comprises a plurality of fuel cell elements arranged along a stacking direction 108, which fuel cell elements are not marked separately with a reference sign in the figures.

The fuel cell elements are in particular plate-shaped units which have different components for the electrochemical conversion of fuel, for conducting power, and for conducting fluid.

The fuel cell stack unit 102 preferably comprises two end plates 110.

The fuel cell stack 106 of the fuel cell stack unit 102 is preferably arranged between the two end plates 110.

The fuel cell stack 106 of the fuel cell stack unit 102 is preferably clamped between the two end plates 110 by means of a clamping device 112—in particular, by means of a plurality of clamping elements 114 of the clamping device 112.

The clamping elements 114 are in particular what are known as “tie rods.”

It may be advantageous if the clamping elements 114 of the clamping device 112 are arranged directly or indirectly on the end plates 110 of the fuel cell stack unit 102 such that the end plates 110 of the fuel cell stack unit 102 are pulled towards one another and/or that a tensile force acts upon the end plates 110 of the fuel cell stack unit 102 which pulls the end plates 110 towards one another.

The fuel cell stack unit 102 preferably comprises an upper end plate 110a and a lower end plate 110b.

The upper end plate 110a and the lower end plate 110b are preferably arranged on end regions 116 of the fuel cell stack unit 102 facing away from one another.

In an operating state of the fuel cell device 100, the upper end plate 110a is arranged, for example, on an upper end region 116a of the fuel cell stack unit 102 in the direction of gravity G, wherein the lower end plate 110b is arranged, for example, on a lower end region 116b of the fuel cell stack unit 102 in the direction of gravity G.

The casing 104 preferably comprises an upper casing lid 118a and a lower casing lid 118b.

The clamping elements 114 of the clamping device 112 of the fuel cell device 100 are preferably secured to a casing lid 118 of the casing 104—in particular, to the lower casing lid 118b.

For example, it is conceivable for the clamping elements 114 to be screwed to the casing lid 118.

The clamping elements 114 are preferably passed through the end plate 110 of the fuel cell stack unit 102, which is secured to the casing lid 118.

The upper casing lid 118a and the lower casing lid 118b of the casing 104 are preferably arranged on end regions 120 of the casing 104 of the fuel cell device 100 facing away from one another.

In an operating state of the fuel cell device 100, the upper casing lid 118a is arranged, for example, on an upper end region 120a of the fuel cell device 100 in the direction of gravity G, wherein the lower casing lid 118b is arranged, for example, on a lower end region 120b of the fuel cell device 100 in the direction of gravity G.

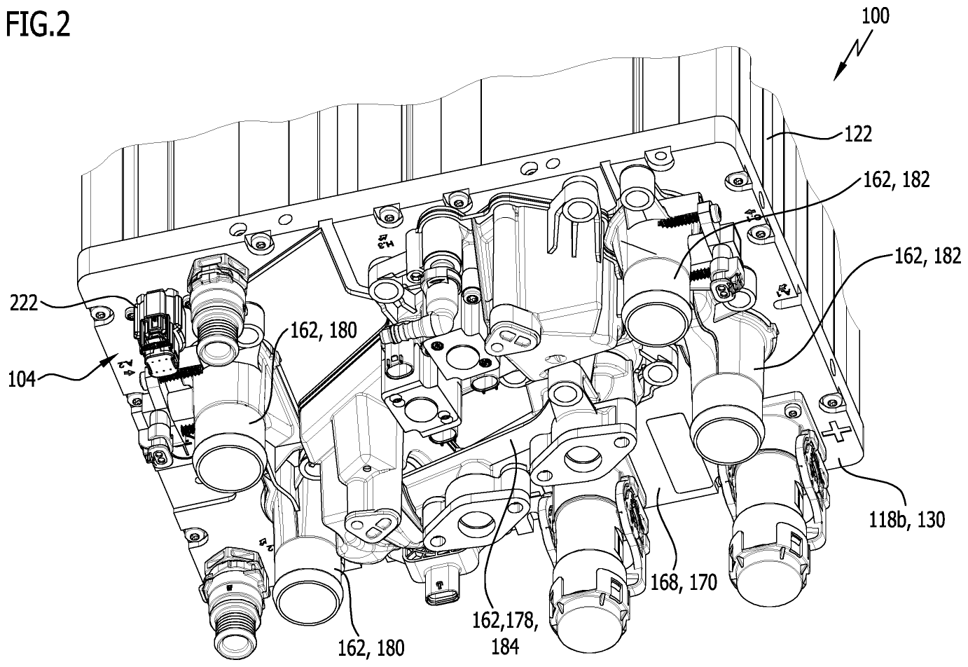

It may be advantageous if the casing 104 also comprises a casing shell 122, shown only in FIG. 2, which preferably connects the upper casing lid 118a and the lower casing lid 118b to one another.

An interior chamber 124 of the casing 104 of the fuel cell device 100, in which the fuel cell stack unit 102 is arranged, is preferably delimited by the upper casing lid 118a, the casing shell 122, and the lower casing lid 118b.

The casing 104 of the fuel cell device 100 preferably encloses the interior chamber 124 of the casing 104 in a gas-tight manner.

The upper casing lid 118a, the lower casing lid 118b, and/or the casing shell 122 preferably comprise or are formed from a metallic material—for example, aluminum.

The fuel cell device 100 preferably comprises a fixed bearing device 126 and a floating bearing device 128.

The fuel cell stack unit 102 is in particular fixedly mounted on one side in the casing 104 of the fuel cell device 100 by means of the fixed bearing device 126.

It may be advantageous if the fuel cell stack unit 102 on one of its end regions 116 is fixedly mounted in the casing 104 of the fuel cell device 100.

In particular, it is conceivable for the fuel cell stack unit 102 to be secured to a wall 130 of the casing 104—in particular, to a casing lid 118 of the casing 104.

The lower end plate 110b of the fuel cell stack unit 102 is preferably secured to the wall 130 of the casing 104—in particular, to the casing lid 118 of the casing 104.

The lower end plate 110b of the fuel cell stack unit 102 is preferably screwed to the lower casing lid 118b.

The end plate 110 of the fuel cell stack unit 102 which is secured to the wall 130—in particular, to the casing lid 118—preferably comprises or is formed from a plastic material.

It may be advantageous if the end plate 110 secured to the wall 130—in particular, to the casing lid 118—is a plastic end plate 136.

The plastic end plate 136 is preferably an injection-molded component 138.

The preferably metallic casing lid 118 of the casing 104 of the fuel cell device 100 to which the plastic end plate 136 is secured preferably forms a pressure distributor plate 140 by means of which a substantially uniform surface pressure can be exerted on the fuel cell elements of the fuel cell stack 106 of the fuel cell stack unit 102.

The end plate 110 of the fuel cell stack unit 102 which is secured to the wall 130—in particular, to the casing lid 118—preferably comprises a plurality of passage portions 142 which are passed through the wall 130—in particular, through the casing lid 118.

The passage portions 142 are preferably designed such that a medium can be passed through them.

For example, an anode gas, a temperature control medium, or a cathode gas can be passed through a passage portion 142 as a medium.

The end plate 110 of the fuel cell stack unit 102 which comprises the passage portions 142 is in particular a media guide end plate 144.

A corresponding passage portion 142 preferably comprises or delimits one or more channel portions 146 of one or more channels 148 by means of which a fluid can be supplied to the fuel cell stack 106 of the fuel cell stack unit 102 or by means of which a fluid can be removed from the fuel cell stack 106 of the fuel cell stack unit 102.

A channel portion 146 of a corresponding passage portion 142 preferably opens into what is known as a “manifold” 150 of the fuel cell stack 106 of the fuel cell stack unit 102.

In the embodiment of a fuel cell device 100 shown in FIGS. 1 to 21, the end plate 110 comprises in particular two passage portions 142, wherein a corresponding passage portion 142 preferably delimits three channel portions 146.

The channel portions 146 of a corresponding passage portion 142 are preferably fluidically separated from one another.

The channel portions 146 are preferably each delimited by a channel wall 152.

Preferably, the channel wall 152 of a corresponding channel portion 146 of a corresponding passage portion 142 has no weld seams.

It may be advantageous if the passage portions 142 are formed in one piece with the end plate 110 which is secured to the wall 130—in particular, to the casing lid 118.

In particular, it can be provided that the passage portions 142 of the plastic end plate 136 be formed in one piece with the plastic end plate 136.

Preferably, leakage in the region of the passage portions 142 can be reduced or avoided by the fact that the passage portions 142 are formed in one piece with the plastic end plate 136 and that the channel wall 152 of a corresponding channel portion 146 of a corresponding passage portion 142 has no weld seams.

The passage portions 142 preferably project away from a base plate 154 of the end plate 110 which is secured to the wall 130—in particular, the casing lid 118.

The passage portions 142 are preferably substantially cylindrical—in particular, in a direction parallel to the stacking direction 112 of the fuel cell stack 106 of the fuel cell stack unit 102.

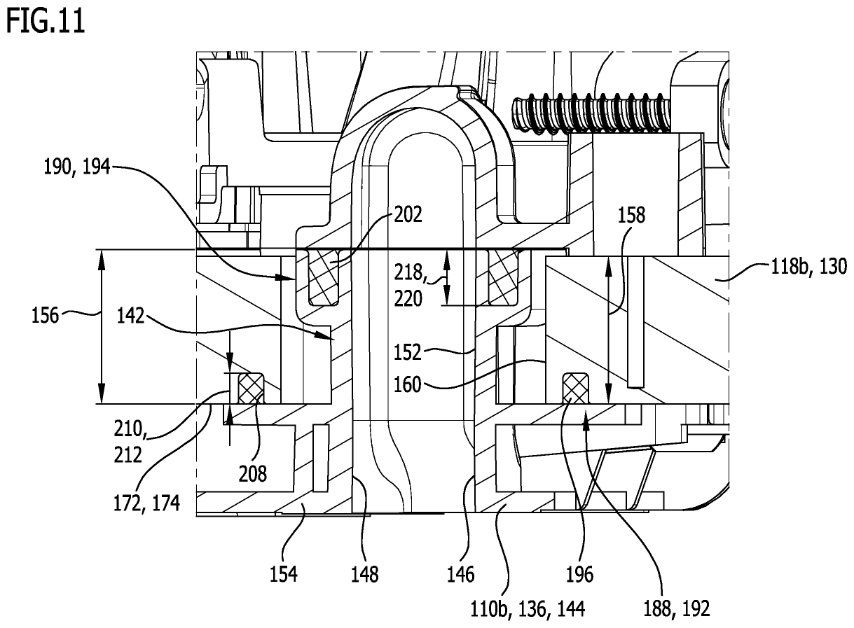

A height 156 of the passage portions 142 is preferably equal to or greater than a thickness 158 of the wall 130—in particular, of the casing lid 118—to which the fuel cell stack unit 102 is secured (cf. FIG. 11).

The wall 130—in particular, the casing lid 118—to which the fuel cell stack unit 102 is secured preferably comprises a plurality of through-openings 160 through which a passage portion 142 of the end plate 110 of the fuel cell stack unit 102 is passed.

The through-openings 160 are preferably substantially cylindrical—in particular, in a direction parallel to the stacking direction 108 of the fuel cell stack 106 of the fuel cell stack unit 102.

It is conceivable, for example, for the passage portions 142 to project from the through-openings 160 of the wall 130—in particular, in the casing lid 118—on an outer side facing away from the interior chamber 124 of the casing 104 of the fuel cell device 100.

A cross-section of the through-openings 160 of the wall 130—in particular, of the casing lid 118—preferably substantially corresponds to a cross-section of the passage portions 142.

The fuel cell device 100 preferably comprises a plurality of media guide elements 162 which are arranged outside the interior chamber 124 of the casing 104 of the fuel cell device 100.

The media guide elements 162 serve in particular to supply and remove anode gas, to supply and remove cathode gas, and/or to supply and remove temperature control medium.

The media guide elements 162 are preferably sealingly connected to the passage portions 142 of the end plate 110 which is secured to the wall 130—in particular, to the casing lid 118.

Preferably, the media guide elements 162 each comprise or delimit a channel portion 164 of a channel 148 by means of which a fluid can be supplied to the fuel cell stack 106 of the fuel cell stack unit 102 or by means of which a fluid can be removed from the fuel cell stack 106 of the fuel cell stack unit 102.

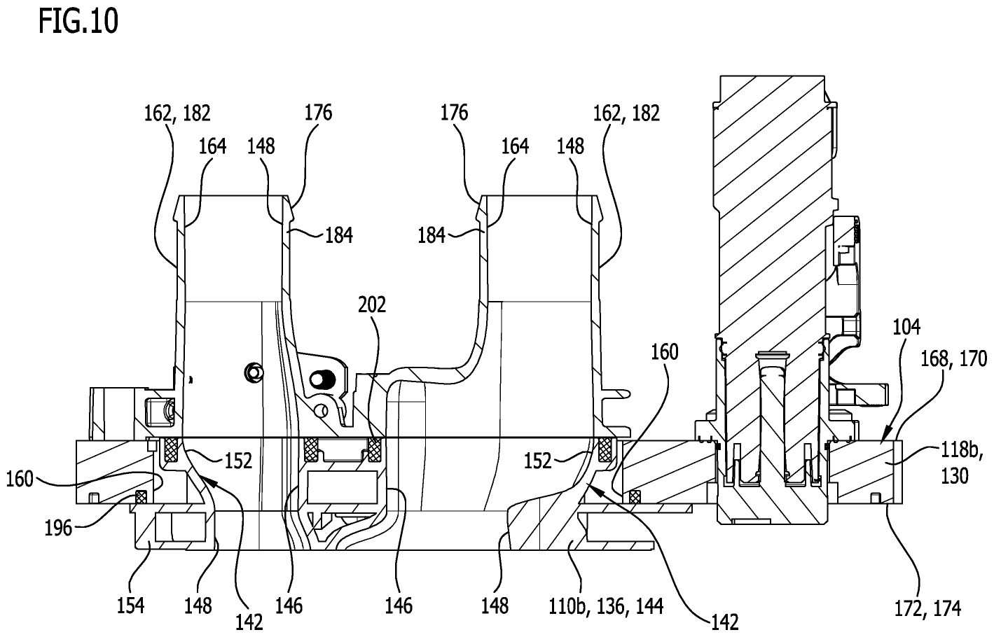

It may be advantageous in particular if the channel portion 164 of a media guide element 162 and a channel portion 146 of a passage portion 142 together form a media guide channel 166, by means of which a fluid can be supplied to the fuel cell stack 106 of the fuel cell stack unit 102 or by means of which a fluid can be removed from the fuel cell stack 106 of the fuel cell stack unit 102 (cf. FIG. 10).

The media guide elements 162 are preferably secured—in particular, releasably—to the wall 130—in particular, to the casing lid 118.

For example, it is conceivable for the media guide elements 162 to be screwed to the wall 130—in particular, to the casing lid 118.

By releasably securing the media guide elements 162, a replacement of the media guide elements 162 and thus preferably also a repair of the fuel cell device 100 can preferably be facilitated.

Preferably, the media guide elements 162 are secured to the first side of the casing lid 118—for example, to an underside 168 of the casing lid 118 and/or to an outer side 170, facing away from the interior chamber 124 of the casing 104 of the fuel cell device 100, of the casing lid 118.

The end plate 110 of the fuel cell stack unit 102 is preferably secured to a second side of the casing lid 118, which faces away from the first side—in particular, to an upper side 172 of the casing lid 172 and/or to an inner side 174, facing the interior chamber 124 of the casing 104 of the fuel cell device 100, of the casing lid 100.

The media guide elements 162 preferably each comprise a media connection 176.

A respective media connection 176 of a media guide element 162 preferably opens into a media guide channel 166.

The media guide elements 162 preferably comprise or are formed from a plastic material.

In particular, it can thereby be achieved that the media connections 176 of the media guide elements 162 are electrically decoupled from the casing lid 118, which is in particular metallic.

As media guide elements 162, the fuel cell device 110 comprises in particular an anode gas guide element 178, two temperature control medium guide elements 180, and two cathode gas guide elements 182.

A channel wall 184 of a channel portion 164 of a corresponding temperature control medium guide element 180 and/or of a corresponding cathode gas guide element 182 preferably has no weld seams.

It may be advantageous if the temperature control medium guide elements 180 and/or the cathode gas guide elements 182 are formed substantially in one piece.

The temperature control medium guide elements 180 and/or the cathode gas guide elements 182 are preferably injection-molded components—in particular, plastic injection-molded components.

It can be provided that the fuel cell device 100 comprise an anode gas guide element 178 which comprises one or more weld seams—for example, one or more hot gas weld seams and/or one or more laser weld seams.

It may be advantageous if, of the media guide elements 162, only the anode gas guide element 178 comprises one or more weld seams—in particular, one or more hot gas weld seams—so that a total length of the weld seams of the fuel cell device 100 is preferably reduced.

The anode gas guide element 178 can in particular be of multipart design.

The anode gas guide element 178 preferably comprises a plurality of injection-molded components—in particular, a plurality of plastic injection-molded components.

It may be particularly advantageous if the anode gas guide element 178 is an anode gas guide module 184.

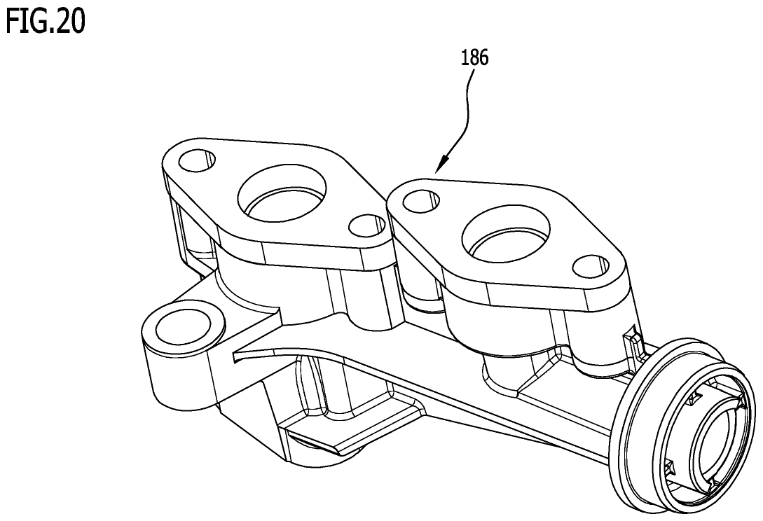

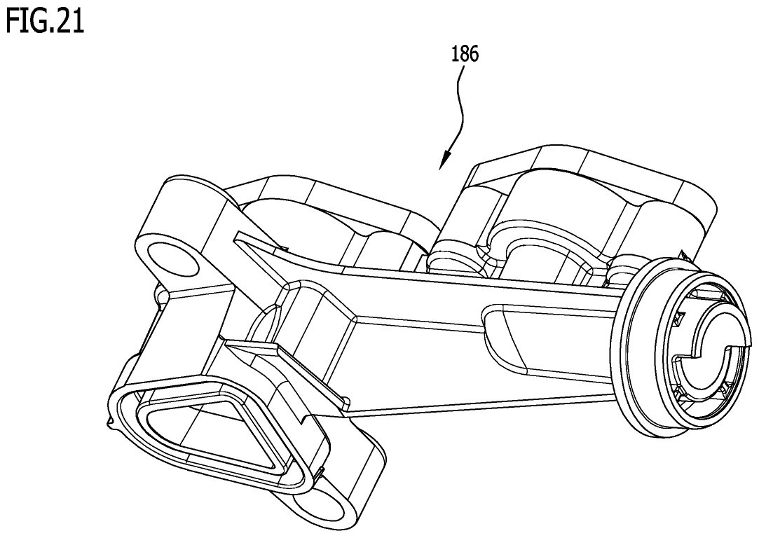

For example, it is conceivable for the anode gas guide element 178 to comprise a passive recirculation element 186, which is shown in FIGS. 20 and 21 and by means of which anode gas and/or fuel can be recirculated.

For sealing the fuel cell device 100, it can be provided that the fuel cell device 100 comprise a first sealing device 188 and a second sealing device 190.

The first sealing device 188 preferably serves for sealing between the wall 130—in particular, the casing lid 118—and the end plate 110 of the fuel cell stack unit 102 which is secured to the wall 130—in particular, to the casing lid 118.

The second sealing device 190 preferably serves for sealing between a corresponding passage portion 142 of the end plate 110 of the fuel cell stack unit 102 which is secured to the wall 130—in particular, the casing lid 118—and a corresponding media guide element 162 of the fuel cell device 100.

The first sealing device 188 is in particular an internal sealing device 192 which is preferably designed for sealing in the interior chamber 124 of the casing 104 of the fuel cell device 100.

The second sealing device 190 is preferably an external sealing device 194 which is preferably designed for sealing on an outer side facing away from the interior chamber 124 of the casing 104 of the fuel cell device 100.

The first sealing device 188 of the fuel cell device 100 preferably comprises a first—in particular, internal—sealing element 196 for sealing between the wall 130—in particular, the casing lid 118—and the end plate 110 of the fuel cell stack unit 102 which is secured to the wall 130—in particular, the casing lid 118.

The first—in particular, internal—sealing element 196 is preferably formed in one piece.

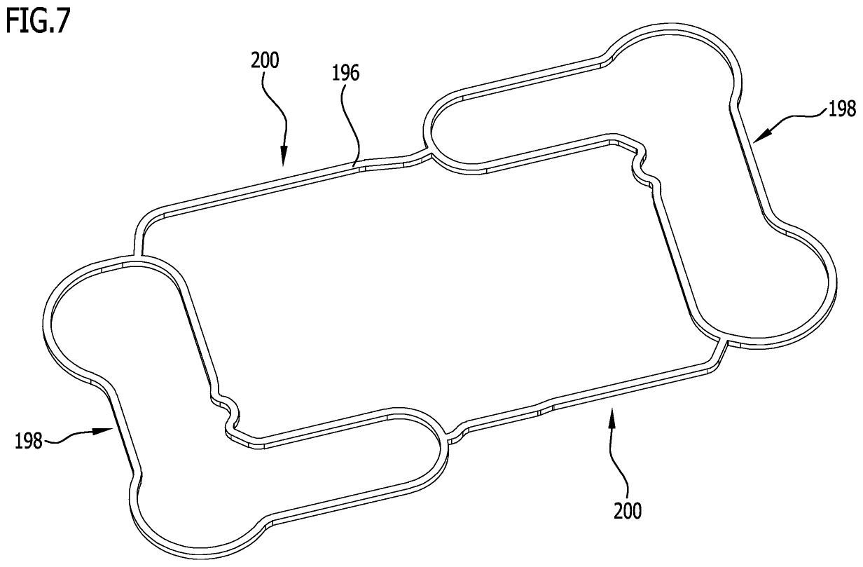

The individual first sealing element 196 preferably comprises two sealing portions 198 and/or two connecting portions 200 (cf. FIG. 7).

A corresponding sealing portion 198 of the individual first sealing element 196 is preferably closed in an annular manner.

In particular, it can be provided that a corresponding sealing portion 198 of the individual first sealing element 196 radially surround a corresponding passage portion 142—in particular, be closed in an annular manner.

Preferably, one connecting portion 200 in each case connects two sealing portions 198 of the individual first sealing element 196 to one another, so that the individual first sealing element 196 is preferably closed in an annular manner overall.

The second sealing device 190 of the fuel cell device 100 preferably comprises two second—in particular, external—sealing elements 202 for sealing between a corresponding passage portion 142 of the end plate 110 of the fuel cell stack unit 102 which is secured to the wall 130—in particular, the casing lid 118—and a corresponding media guide element 162 of the fuel cell device 100.

The two second sealing elements 202 are preferably each formed in one piece.

The channel portion 164 of a corresponding media guide element 162 is preferably sealingly connected to the channel portion 146 of a corresponding passage portion 142 by means of a second sealing element 202.

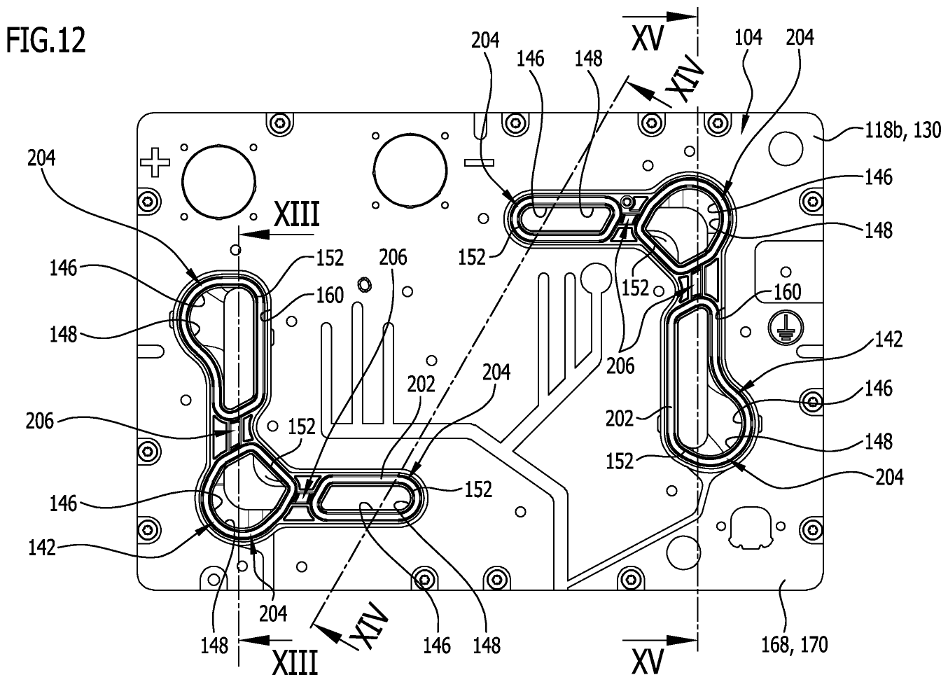

The two second sealing elements 202 preferably each comprise three sealing portions 204 and/or two connecting portions 206 (cf. FIG. 12).

A corresponding sealing portion 204 of the two second sealing elements 202 is preferably closed in an annular manner.

In particular, it can be provided that a corresponding sealing portion 204 of a second sealing element 202 radially surround a channel portion 164 of a media guide element 162—in particular, be closed in an annular manner.

Preferably, a corresponding connecting portion 206 of the two second sealing elements 202 connects two sealing portions 204 of the two second sealing elements 202.

The individual first sealing element 196 and/or the two second sealing elements 202 are preferably molded seals.

The first sealing element 196 and the two second sealing elements 202 preferably comprise or are formed from a plastic material—in particular, an elastomeric material.

It may be advantageous if the wall 130—in particular, the casing lid 118—to which the end plate 110 of the fuel cell stack unit 102 is secured and/or the end plate 110 which is secured to the wall 130—in particular, to the casing lid 118—comprises a first receiving groove 208 for receiving the individual first sealing element 196.

In particular, it can be provided that the wall 130—in particular, the casing lid 118—to which the end plate 110 of the fuel cell stack unit 102 is secured comprise on the inner side 174 facing the interior chamber 124 of the casing 104 a single first receiving groove 208 for receiving the individual first sealing element 196.

A shape of the individual first receiving groove 208 preferably corresponds to a shape of the individual first sealing element 196.

The individual first receiving groove 208 has, for example, a rectangular cross-section and can therefore in particular be a rectangular groove.

It may be advantageous if the first receiving groove 208 has a depth 210 which is less than a thickness 212 of the first sealing element 196 in a state before assembly of the fuel cell device 100 (cf. FIG. 11).

The first sealing element 196 is preferably compressed between the inner side 174, facing the interior chamber 124 of the casing 104, of the wall 130—in particular, of the casing lid 118—to which the end plate 110 of the fuel cell stack unit 102 is secured, and the end plate 110 which is secured to the wall 130—in particular, to the casing lid 118.

It may also be advantageous if an end face 214 of the passage portions 142 of the end plate 110 of the fuel cell stack unit 102 which is secured to the wall 130—in particular, to the casing lid 118—comprises a second receiving groove 216 for receiving a respective second sealing element 202.

A shape of the corresponding second receiving groove 216 preferably corresponds to a shape of a corresponding second sealing element 202.

A corresponding second receiving groove 216 has, for example, a rectangular cross-section and can therefore in particular be a rectangular groove.

It may also be advantageous if a corresponding second receiving groove 216 has a depth 218 which is less than a thickness 220 of a corresponding second sealing element 202 in a state before assembly of the fuel cell device 100 (cf. FIG. 11).

The two second sealing elements 202 are preferably compressed between the end face 214 of a corresponding passage portion 142 of the end plate 110 of the fuel cell stack unit 102 which is secured to the wall 130—in particular, to the casing lid 118—and a corresponding media guide element 162.

It may be advantageous if valves, sensors 222, and/or actuators of the fuel cell device 100 are arranged outside the interior chamber 124 of the casing 104, which interior chamber is delimited by the casing 104 of the fuel cell device 100.

Valves, sensors 222, and/or actuators of the fuel cell device 100 can, for example, be secured to the outer side 170, facing away from the interior chamber 124 of the casing 104, of the casing lid 118.

Alternatively or additionally, it can be provided that valves, sensors 222, and/or actuators of the fuel cell device 100 be secured to the media guide elements 162 of the fuel cell device 100.

Preferably, it can be achieved here that connecting cables for the valves, sensors 222, and/or actuators do not have to be passed through the casing 104—in particular, not through the casing lid 118.

In particular, an additional sealing point can thereby be dispensed with.

Overall, a fuel cell device 100 can preferably be provided which is easy and cost-effective to manufacture and can be safely operated.

1. Fuel cell device, wherein the fuel cell device comprises the following:
a fuel cell stack unit;
a casing which delimits an interior chamber, in which the fuel cell stack unit is arranged;
wherein the casing comprises at least one wall—preferably a casing lid—
wherein the fuel cell stack unit is secured to the wall—preferably to the casing lid.

2. Fuel cell device according to claim 1, wherein the fuel cell device comprises a fixed bearing device and/or a floating bearing device.

3. Fuel cell device according to claim 1, wherein an end plate of the fuel cell stack unit is secured to the wall—in particular, to the casing lid—wherein the end plate of the fuel cell stack unit which is secured to the wall—in particular, to the casing lid—preferably comprises or is formed from a plastic material.

4. Fuel cell device according to claim 1, wherein an end plate of the fuel cell stack unit, which end plate is secured to the wall—in particular, to the casing lid—comprises one or more passage portions which are passed through the wall—in particular, through the casing lid—wherein the passage portions are preferably designed such that a medium can be passed through them.

5. Fuel cell stack unit according to claim 4, wherein a channel wall of a channel portion of a corresponding passage portion has no weld seams.

6. Fuel cell stack unit according to claim 4, wherein the passage portions project away from a base plate of the end plate, which is secured to the wall—in particular, to the casing lid.

7. Fuel cell stack unit according to claim 4, wherein a height of the passage portions is equal to or greater than a thickness of the wall—in particular, of the casing lid—to which the fuel cell stack unit is secured.

8. Fuel cell device according to claim 1, wherein the wall—in particular, the casing lid—to which the fuel cell stack unit is secured, comprises one or more through-openings through which one or more passage portions of an end plate of the fuel cell stack unit are passed.

9. Fuel cell device according to claim 1, wherein the fuel cell device further comprises one or more media guide elements which are arranged outside the interior chamber of the casing of the fuel cell device.

10. Fuel cell device according to claim 1, wherein the fuel cell device further comprises:
a) a first sealing device for sealing between the wall—in particular, the casing lid—and an end plate of the fuel cell stack unit which is secured to the wall—in particular, to the casing lid; and/or
b) a second sealing device for sealing between a passage portion of an end plate of the fuel cell stack unit which is secured to the wall—in particular, to the casing lid—and a media guide element of the fuel cell device.

11. Fuel cell device according to claim 1, wherein the fuel cell device comprises media connections arranged outside the casing of the fuel cell device, wherein a corresponding media connection opens into a media guide channel which comprises channel portions of a media guide element and/or a passage portion of an end plate of the fuel cell stack unit which is secured to the wall—in particular, to the casing lid.

12. Fuel cell device according to claim 1, wherein the fuel cell device comprises:
a) one or more first—in particular, internal—sealing elements for sealing between the wall—in particular, the casing lid—and an end plate of the fuel cell stack unit which is secured to the wall—in particular, to the casing lid; and/or
b) one or more second—in particular, external—sealing elements for sealing between a passage portion of an end plate of the fuel cell stack unit which is secured to the wall—in particular, to the casing lid—and a media guide element of the fuel cell device.

13. Fuel cell device according to claim 1, wherein
a) the wall—in particular, a casing lid—to which an end plate of the fuel cell stack unit is secured and/or the end plate which is secured to the wall—in particular, to the casing lid—comprises one or more first receiving grooves for receiving one or more first sealing elements; and/or
b) an end face of a corresponding passage portion of an end plate of the fuel cell stack unit which is secured to the wall—in particular, to the casing lid—comprises one or more second receiving grooves for receiving one or more second sealing elements.

14. Fuel cell device according to claim 1, wherein clamping elements of a clamping device of the fuel cell device are secured to a casing lid of the casing—in particular, to a lower casing lid.

15. Fuel cell device according to claim 1, wherein valves, sensors, and/or actuators of the fuel cell device are arranged outside the interior chamber, delimited by the casing of the fuel cell device, of the casing of the fuel cell device.
